(19) United States
(12) Patent Application Publication
(10) Pub. No.: US 2026/0231950 A1
(43) Pub. Date: Aug. 13, 2026

(54) SYNERGISTIC IRON AND AMINO ACIDS COMBINATION OPERATIVE AS AN HERBICIDE

(71) Applicant: The Andersons Inc., Maumee, OH (US)

(72) Inventors: Michael T. Rainey-Smithback, Maumee, OH (US); Joseph Schumski, Maumee, OH (US)

(73) Assignee: The Andersons Inc., Maumee, OH (US)

(21) Appl. No.: 19/532,142

(22) Filed: Feb. 6, 2026

Related U.S. Application Data
(60) Provisional application No. 63/755,468, filed on Feb. 7, 2025.

(51) Int. Cl. A01N 59/16; A01N 25/12; A01N 37/18; A01N 37/46; A01N 63/10; A01N 65/44; A01P 13/02

(52) U.S. Cl. CPC A01N 59/16; A01N 25/12; A01N 37/18; A01N 37/46; A01N 63/10; A01N 65/44; A01P 13/02

(57) ABSTRACT

An herbicide composition is provided that includes an iron compound. At least one type of monoamino acid or dimer of amino acids is also present in the composition. A process of promoting killing a target broadleaf plant or moss therewith is also provided that includes spreading the composition on soil in which the target plant is growing and then allowing the material to disperse into the soil.

### RELATED APPLICATIONS

This application is a non-provisional application that claims priority benefit of U.S. Provisional Application Ser. No. 63/755,468, filed Feb. 7, 2025; the contents of which are hereby incorporated by reference.

### FIELD OF THE INVENTION

The present invention relates in general to an herbicide, and in particular to a composition of inorganic iron with amino acids, provided as a liquid or with a delivery particle.

### BACKGROUND OF THE INVENTION

Iron(EDTA), or iron chelated with ethylenediaminetetraacetic acid, is increasingly being used as a replacement for traditional herbicides due to its unique properties and environmental benefits.

Iron(EDTA) is a selective herbicide effective against broadleaf weeds and without harming desirable grasses common to lawns and golf courses. This selectivity is crucial for maintaining healthy lawns and landscapes while effectively managing weed populations. The generally accepted mode of action is believed to be that broadleaf weeds absorb iron(EDTA) more readily than grasses thereby leading to iron toxicity in the weeds.

While iron(EDTA) has a better environmental safety compared to conventional herbicides, such as glyphosate, 3,6-dichloro-2-methoxybenzoic acid, and 2,4-dichlorophenoxyacetic acid; EDTA is still of some concern as a persistent substance in the environment and its contribution to heavy metals bioavailability and remobilization processes in the environment. Health Canada, Environment and Climate Change Canada “Final Screening Assessment EDTA and Its Salts Group” (May 2018).

Iron(EDTA) is routinely applied to target crops by methods including liquid sprays and granules. These methods have met with limited acceptance on the basis that liquid application requires a degree of expertise to avoid drift while a comixture with sugar or other substances is prone to clumping and difficult to dissolve under ambient conditions. Still another limitation of iron(EDTA) is the comparatively high concentrations of iron needed to be effective, with typical concentrations being around 1.8 percent of iron(EDTA) being conventional.

Thus, there is a need for new compositions to deliver herbicidal iron to a target crop. There further exists a need for compositions that are more efficacious than iron (EDTA). There also exists a need for improved delivery particles for the delivery of the aforementioned compositions.

### SUMMARY OF THE INVENTION

An herbicide composition is provided that includes an iron compound. At least one type of monoamino acid or dimer of amino acids is also present in the composition

A process of promoting killing a target broadleaf plant or moss therewith is also provided that includes spreading the composition on soil in which the target plant is growing and then allowing the material to disperse into the soil.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings wherein:

FIG. 1 is a schematic cross-sectional view of an inventive particle with a unitary carrier particle core;

FIG. 2 is a schematic cross-sectional view of another embodiment of an inventive particle with a granular carrier particle core;

FIG. 3 is a schematic cross-sectional view of another embodiment of an inventive particle with a granular amino acid particle with the surface decorated with inorganic iron salts;

FIG. 4 is a schematic cross-sectional view of another embodiment of an inventive particle with a granular inorganic iron particle with the surface decorated with amino acids; and

FIG. 5 is a plot of an inventive particle compared to other treatments for moss control based on a grid plots from May through October 2025 in Illinois, USA

### DETAILED DESCRIPTION OF THE INVENTION

The present invention relates to a novel composition for delivery of herbicidal iron, with a synergistic amount of amino acid, dimer of amino acids or a combination thereof. In some inventive embodiments, the combination is devoid of EDTA. In still other inventive embodiments, the iron and amino acids are applied to a carrier granule to form a free-flowing particle composition that is amenable to broadcast distribution. The resulting particles are amenable to broadcast application, for example via rotary or drop spreader. As a result, a dust-free particle is formed that simultaneously addresses the prior art problems of.

The following description of the preferred embodiment(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only. One of ordinary skill in the art readily understands that the individual components of the inventions are interchangeable and their description with respect to a single embodiment does not preclude their use in alternative embodiments.

As used herein, the term “monoamino acid” refers to the twenty naturally occurring L-amino acids, and salts thereof such as sodium, potassium, and calcium salts, and combinations thereof. It is appreciated that a monoamino acid need not be in purified form to function in the present invention.

As used herein, the term “dimer of amino acid” refers to a dimer of at least one of twenty naturally occurring L-amino acids coupled to a second amino acid with an amide bond therebetween, and salts thereof such as sodium, potassium, and calcium salts, and combinations thereof. It is appreciated that a dimer of amino acid need not be in purified form to function in the present invention.

It is to be understood that in instances where a range of values are provided herein, that the range is intended to encompass not only the end point values of the range, but also intermediate values of the range as explicitly being included within the range and varying by the last significant figure of the range. By way of example, a recited range of from 1 to 4 is intended to include 1-2, 1-3, 2-4, 3-4, and 1-4.

The present invention relates to compositions for delivery of herbicidal iron, and amino acids to a plant. The inventive composition is provided in liquid form, or as a coating or pair of coatings on a carrier particle. In still other embodiments, a solution amino acids is applied onto a granular iron containing particle, or vice versa with a solution of iron salts applied onto an amino acid particle. A coating of a soluble iron salt onto a granular lysine particle is exemplary of this form of the present invention. An inventive composition, regardless of the form affords efficacy at lower levels of iron compared to conventional compositions to provide herbicidal effect. The particle form provides improved storage capabilities for materials while being free flowing and thereby easier to deliver. The resulting particles are amenable to broadcast application, for example via rotary or drop spreader.

The invention further relates to a method for making and using the particulate material.

In one embodiment of the present invention, conventional iron(EDTA) is formulated with monoamino acids, dimer of amino acids, or a combination thereof. The iron: amino acid molar ratio being greater than 1:0.5 and in other embodiments between 1:0.5-20. The inclusion of the amino acid in the form or a monoamino acid, dimer of amino acid, or a combination thereof appears to competitively bind to iron relative to the acetic acid moieties of EDTA thereby rendering the iron more amenable to bioabsorption and as the amino acids are metabolized, less loading of iron is required. In such inventive embodiments, conventional iron(EDTA) is used more efficiently.

Iron-amino acid chelates, and their synthesis are well known to the art as detailed in U.S. Pat. Nos. 4,020,158; 4,167,564; 4,216,143; 4,216,144; 4,599,152; 4,774,089; 4,830,716; and 4,863,898. Amino acids are bidentate ligands able to bind through both the amine and carboxylate moieties; while some amino acids include additional chelating groups such as thiols, additional amines, and carboxyl groups. Iron-amino acid chelates are commonly used as nutritional supplements and soil amendments. Iron-amino acid chelates are trivial to make by simply combining a water soluble type of iron, such as iron sulfate or chloride with stoichiometric amounts of amino acids in water and heating to approximately 80 to 100 degrees Celsius for 30 to 120 minutes.

The present invention does not need to form iron-amino acid chelates and instead the simple co-administration is sufficient to produce an improved herbicidal effect relative to iron(EDTA) alone or other iron chelated herbicides.

While iron(EDTA) is functional in the present invention, activity is achieved through resort to an inorganic iron source and without the need for bio-persistent EDTA. Suitable sources of iron include iron sulfate, iron chloride, iron nitrate, iron citrate, iron ascorbate, iron oxide, and combinations thereof. It is appreciated that Fe(2+) is typically more soluble than Fe(3+) salts in the present invention, yet the invention detailed herein is operative with both charge salts and insoluble forms of iron cations.

The iron: amino acid molar ratio in a composition lacking EDTA is greater than 1:0.8 and in other embodiments between 1:0.8-20. Amino acids operative herein include all twenty naturally occurring, common L-amino acids of alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine. While the essential, uncommon amino acids of selenocysteine, and pyrrolysine are operative herein, the usage of the present invention as an herbicide cannot support the cost and complexity of the specific use thereof. In some inventive embodiments, amino acids are present that are positively charged (arginine, histidine, or lysine), negatively charged (aspartic acid, glutamic acid), or cysteine. Without intending to be bound to a particular theory, the presence of a charged amino acid or cysteine promotes both in situ chelation and plant uptake through target plant roots. The amino acids need not be purified. Instead, hydrolyzed protein provides a soluble mixture of amino acids. Plentiful sources of hydrolyzed protein include feathers, hair, offal, animal waste, and combinations thereof.

Dimers of amino acids operative herein include a pair of any of the aforementioned amino acids covalently bonded with an amide bond therebetween.

Regardless of the form, the iron and amino acids of the present invention need not be reacted to form a chelate prior to administration to the target plant. As a result, a solution of water soluble iron and amino acid is administered to the target plant. Solutions that are from 0.05 to 5 total weight percent iron are readily administered to control broadleaf weeds, mosses, or a combination thereof. In still other embodiments, the solution contains 0.1 to 2.3 total weight percent iron are readily administered to control broadleaf weeds, mosses, or a combination thereof.

A finished particle of an inventive combination is sized for broadcast distribution. The particle includes a carrier particle in which the iron and amino acid are intermixed or coated. In still other embodiments, the one of iron or the amino acids is a particle on which the other forms a coating.

The carrier particle according to the present invention is either a unitary piece or a combination of granules agglomerated to a desired carrier particle size. The functionality of an inventive particle is largely independent of grind size of the constituent pieces. Mesh sizes as referred to herein are U.S. standard sieve sizes per ASTM E11:01 where a positive (+) sign denotes material that does not pass a given mesh, while a negative (−) sign denotes material that passes through a given mesh.

The constituent granules of constituent granules are typically sized to have less than 5 weight percent being +40 mesh and more than 20 weight percent being −100 mesh. In still other inventive embodiments, the constituent granules are 100 weight percent being −40 mesh. In still other inventive embodiments, greater than 40 weight percent of the constituent granules are −100 mesh weight percent. In still other inventive embodiments, greater than 60 weight percent of the constituent granules are −100 mesh weight percent. In still other inventive embodiments, greater than 5 weight percent of the constituent granules are −200 mesh weight percent. In still other inventive embodiments, greater than 30 weight percent of the constituent granules are −200 mesh weight percent.

Typically, a carrier particle has a size from 20 to 3000 microns, regardless of composition. Suitable carrier particles regardless of whether unitary of composed on constituent granules illustratively include fragmented materials such as rock dust, clay, biochar, humic acid, paper pulp, corncob, cereal or grain hulls, peanut hulls, plant pulp, other plant-based cellulosic materials, clays, fertilizers, and combinations thereof. Specific examples of base carrier particles include limestone particulate having a mean particle size of 1000 microns; blended fertilizer composed of urea, diammonium phosphate, and potassium chloride having a mean particle size of 2150 microns; dried distillers grain (defatted, extruded corn granules having a mean particle size of 1500 microns). A carrier particle formed through the combination of constituent granules with binder typically present from 0.5 to 10 total weight percent of binder.

A binder component is present in a carrier particle in an amount ranging from 0 to 20 percent by total weight of the dry weight of the inventive particle. In a further embodiment, the binder component is present in an amount ranging from 0.5 to 10 percent by weight of the dry weight of the inventive particle. A binder component is included in a particle as necessary to produce or promote cohesion of constituent granules in forming a carrier particle capable of retaining a specified form during transport and/or distribution and inhibits the dusting and attrition associated with prior art products. Another use of a binder is to adhere particulate forms of iron, amino acids, or a combination thereof to a carrier particle outer surface.

A binder component operative herein includes bentonite clay, carbohydrate, protein, lipid, synthetic polymer, glycolipid, glycoprotein, lipoprotein, lignin, a lignin derivative, a carbohydrate-based composition, and a combination thereof. Carbohydrate binder components operative herein illustratively include a monosaccharide, a disaccharide, an oligosaccharide, a polysaccharide and combinations thereof. Specific carbohydrate binders illustratively include glucose, mannose, fructose, galactose, sucrose, lactose, maltose, xylose, arabinose, trehalose and mixtures thereof such as corn syrup; celluloses such as carboxymethylcellulose, ethylcellulose, hydroxyethylcellulose, hydroxy-methylethylcellulose, hydroxyethylpropylcellulose, methylhydroxyethyl-cellulose, methylcellulose; starches such as amylose, seagel, starch acetates, starch hydroxyethyl ethers, ionic starches, long-chain alkyl starches, dextrins, amine starches, phosphates starches, and dialdehyde starches; plant starches such as corn starch and potato starch; other carbohydrates such as pectin, amylopectin, xylan, glycogen, agar, alginic acid, phycocolloids, chitin, gum arabic, guar gum, gum karaya, gum tragacanth locust bean gum, and complex carbohydrate-based compositions containing organic and inorganic ingredients such as molasses. Oil binder components operative herein illustratively include vegetable oils such as corn, soybean, peanut, canola, olive and cotton seed. Lignin binder components operative herein include a lignin and nitrolignin; derivatives of lignin such as lignosulfonate salts illustratively including calcium lignosulfonate and sodium lignosulfonate and complex carbohydrate-based compositions containing organic and inorganic ingredients such as molasses. Suitable protein binders operative herein illustratively include soy extract, albumin, zein, protamine, collagen, and casein. Binders operative herein also include synthetic organic polymers capable of promoting or producing cohesion of particle components and such binders illustratively include ethylene oxide polymers, polyacrylamides, polyacrylates, polyvinyl pyrrolidone, polyethylene glycol, polyvinyl alcohol, polyvinylmethyl ether, polyvinyl acrylates, polylactic acid, and latex. In specific inventive embodiments, the binder component is a lignin derivative and in still other inventive embodiments is calcium lignosulfonate. In other inventive embodiments, the binder component is molasses, a liquid corn starch, a liquid corn syrup, or a combination thereof. It is appreciated that a water soluble or water swellable binder is particularly well suited to impart water dispersibility to an inventive particle.

The solutions, slurries, or particles of the present invention in some inventive embodiments also include an active ingredient, while in other inventive embodiments no active ingredient is present. Illustrative examples of active ingredients include fertilizers, soil nutrients, amendment materials, and biostimulants. A powdered or liquid active ingredient is recognized to be operative herein. It will be recognized by those skilled in the art that more than one active ingredient may be incorporated into the particle and that the choice of active ingredient or combination of active ingredients will depend on the intended purpose of the particle and the chemical compatibility of the ingredients and other particles components. An active ingredient, if present, is included in an amount ranging from 0.05 to 10 percent by weight of the total dry weight of the particle, and the total amount of active ingredients typically are from up to 18 weight percent of the total dry weight of the particle. It is appreciated that active ingredients present in a coating on the particle are considered part of the total particle.

Fertilizers are substances containing one of the plant nutrients nitrogen, phosphate, or potassium and illustratively include urea, sulfur-coated urea, isobutylidene diurea, ammonium nitrate, ammonium sulfate, ammonium phosphate, triple super phosphate, phosphoric acid, potassium sulphate, sodium nitrate, potassium nitrate, potassium metaphosphate, potassium chloride, dipotassium carbonate, potassium oxide, and a combination of these. These and other fertilizers as active ingredients delivered by the inventive particles are readily intermixed to achieve a variety of levels of nitrogen-phosphorus-potassium, as commonly referred to as an N—P—K rating for the fertilizer.

Soil nutrients illustratively include calcium, magnesium, sulfur, iron, manganese, copper, zinc; oxides thereof, salts thereof, and combinations of the aforementioned. It is appreciated that humics are well suited to chelate soil nutrient metal ions.

Amendment materials are natural organic products such as blood meal, bone meal, seed meal, feather meal, and soy meal; meat meal; animal waste from various animal sources; activated sludge, hydrolyzed animal hair; fish byproducts; compost; and a combination thereof.

Biostimulants are substances that promote plant survival and health and illustratively include plant growth hormones and plant growth regulators such as cytokinins, auxins, gibberellins, ethylene, absisic acid, and a combination of these.

A pH modifier is added in some embodiments to titrate to a desired pH. pH modifiers operative herein illustratively include soda ash, sodium hydroxide, sodium bi-carbonate, sodium silicate, sodium phosphates, lime, and sulfuric acid. In some embodiments, a pH modifier is present in an amount to achieve a dispersion pH of 3.3 and 8.1.

An active ingredient is readily formulated within, or on the surface of an inventive particle or both within the particle and decorating the surface thereof. An active ingredient is readily incorporated into an inventive particle regardless of whether in the active ingredient is in the form of granules, powders, or a liquid. It is appreciated that an active ingredient is readily compounded with inner fillers, dust control aids, flow aids, solvents, surfactants that are used alone or in combination with other active ingredients as part of an inventive particle to promote particle formation and stabilization of the active ingredient.

The particles of the present invention have a mean particle domain size that ranges from 0.1 mm to 30 mm. In specific embodiments, the mean particle domain size ranges from 0.25 mm to 20 mm while in still other embodiments the mean particle domain size ranges from 0.5 mm to 15 mm.

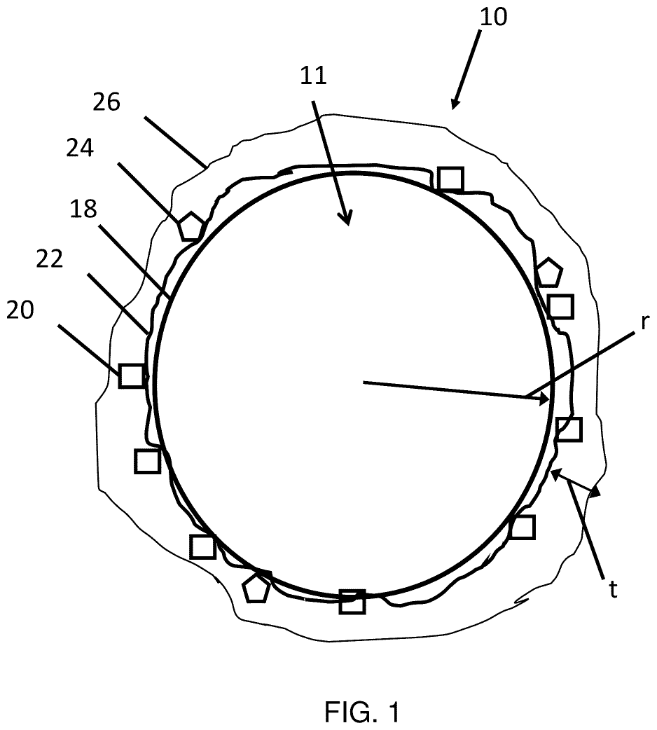

Referring now to FIG. 1, an inventive particle is shown generally at 10. The particle 10 has a unitary carrier particle 11 formed of any of the aforementioned materials to define a particle surface 18 with a particle radius, r. An iron containing compound such as a chelated iron compound, a water soluble iron salt, iron oxide, or combinations thereof 20 is present in the on the particle surface 18. A solution of amino acids is depicted as a dried coating 22 on the surface 18. The surface amino acid coating 22 is optionally provided on the particle surface 18 that in some embodiments contains an active ingredient 24 depicted graphically as a pentagon. The surface amino acid coating 22. As will be detailed with respect to the Examples, iron compounds 20, amino acids, 22, or a combination thereof are readily mixed with a limited amount of water and combined with pre-formed carrier particles, even if the carrier particles have a degree of water solubility, to adhere the iron compounds 20, amino acids, 22, or a combination thereof to the carrier particle 11. Optionally, an coating overlies the coating 26 with a thickness, t and provides properties surface improved flowability, delayed release of iron and amino acid to the soil, or a combination thereof. In some embodiments, the linear ratio r:t is between 1:0.000001-0.3.

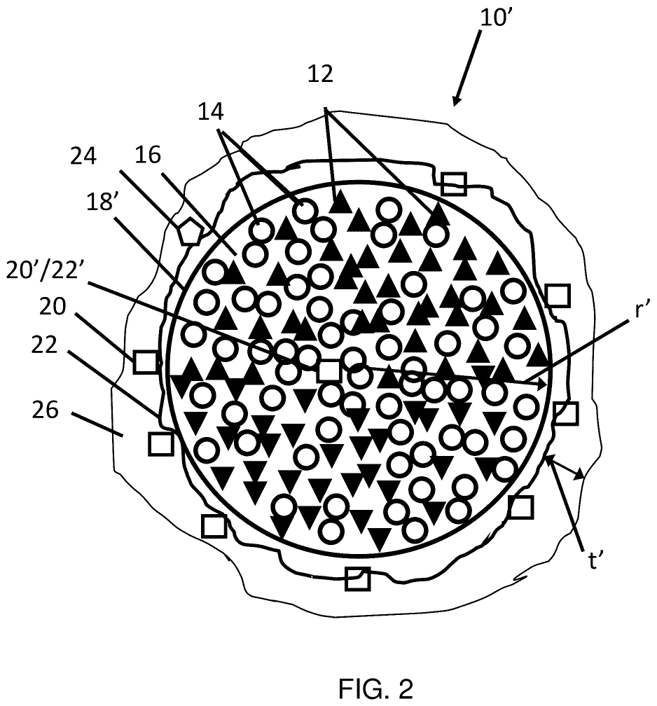

Referring now to FIG. 2, where like reference numerals have the meanings ascribed thereto with respect to previously detailed FIG. 1, an inventive particle is shown generally at 10′. The particle 10′ has a granular carrier particle 11′ composed of a first granular material 12 depicted graphically as filled triangles and a second granular material 14 depicted graphically as open circles that are adhered by binder 16 that forms a matrix that defined a particle surface 18′ with a particle radius, r. Optionally, iron containing compound 20′, amino acids 22′, or a combination thereof are present in the binder matrix 16 as granules or a solute in binder 16, or a combination thereof. A surface coating 26 is optionally provided on the particle surface 18 that in some embodiments contains an active ingredient 24. The coating 26 has a thickness, t that defined linear ratio r: t that is between 0.00001-3:1. Optionally, the active ingredient 20 in the binder matrix 16 is a different active ingredient 20′ relative to that in the coating 22 as a solute or granulate.

The coating 26 is included to provide a harder outer shell relative to an inventive particle. The coating material is added directly to the dried, finished particles and enhances the strength of the particles to prevent degradation. A typical coating material is polyvinyl alcohol or polyacrylic acid. However, other coating compositions capable of strengthening the granules without adversely affecting the desired dispersal properties are suitable for use with the present invention.

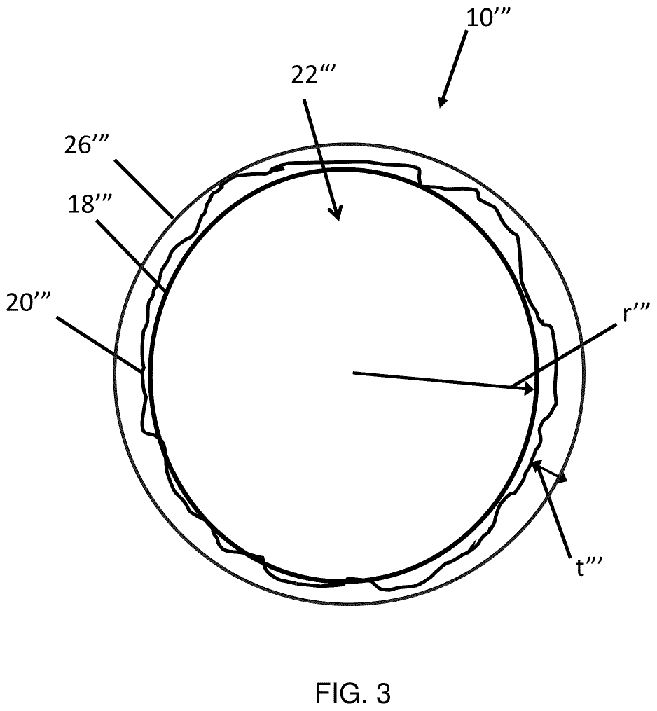

Referring now to FIG. 3, where like reference numerals have the meanings ascribed thereto with respect to previously detailed drawings, an inventive particle is shown generally at 10″. The particle 10″ has a core particle 22″′ of amino acids with a particle radius, r″. Water soluble particle 22″′ are commercially available containing purified or partially purified amino acids and commonly used as human and animal food supplements. Exemplary of these are alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, and valine. The particles 22′″ are mixed with iron containing compound 20′″ wet with a limited amount of water to cause adhesion of the iron containing compound 20′″ to the surface 18″′ of the particles 22″′. In some inventive embodiments, a binder (not shown) is present with the iron containing compound 20″ to promote adhesion, alone or in the presence of some amount of water to render the surfaces tacky. In still other embodiments, an adhesive coating 26″′ is optionally provided on the particle surface 18′″ to encapsulate the iron containing compound 20′″. The coating 26′″ has a thickness, t′″ that defined linear ratio r′″:t′″ that is between 0.000001-3:1.

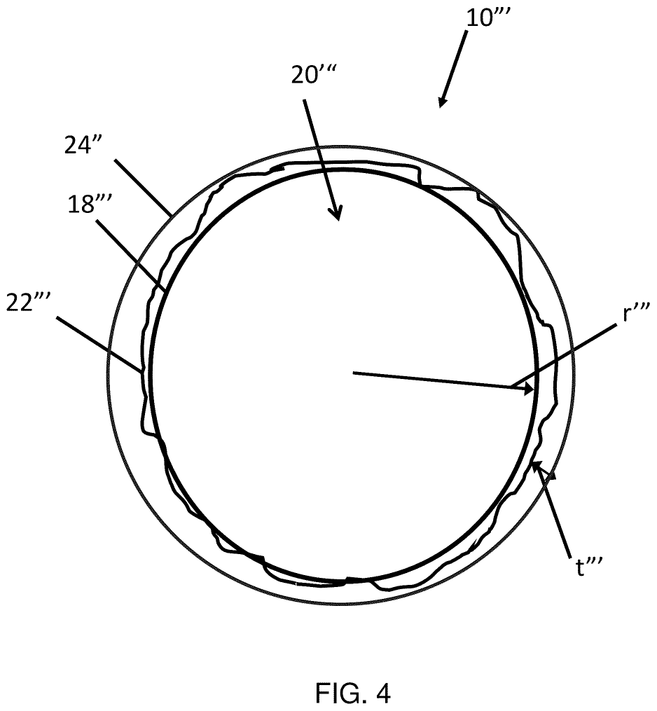

A variant of FIG. 3 reverses the relative position of the iron containing compound 20″ and the amino acid 22″ as denoted in FIG. 4 where like reference numerals have the meanings ascribed thereto with respect to previously detailed drawings.

Formation of an inventive particle readily occurs through pan agglomeration of granular iron compounds and/or granular amino acids with a binder in a suitable solvent. Water soluble iron containing compounds and amino acids are simply mixed to form a solution for delivery or if a carrier particle is used, simply sprayed onto the carrier particle either sequentially or simultaneously. If present, an active ingredient is similarly introduced.

The formation of unitary and granular carrier particles is well known to the art. To the extent that iron compounds and/or amino acids are intermixed within a carrier particle matrix, this is readily done during pan agglomeration to form the carrier particle.

The binder is generally added to the composition as a solution. The solution is typically provided as a water-based slurry having about 40 to 50 percent solids by weight and weighing about 10 pounds per gallon. The binder may also be added and mixed with the other dry ingredients, subsequently mixing in an amount of water.

The admixture is then fed into a pelletizing apparatus to produce the manufactured granules of the present invention. Conventional pelletizing equipment is suitable for use in producing the particle. Optionally, pelletizing equipment is an agglomeration pan. Additionally, drum granulators or other types of granulation equipment may be used to produce the granules of the present invention.

In accordance with the present invention, the operation of an agglomeration pan may vary with the specific formulation or ingredients in order to produce a particle with the preferred properties. For example, feed rates and locations of the admixture or the water, the angle of the pan, the speed of rotation of the disc, or the depth of the pan may be varied to produce the desired product. One skilled in the art of pelletizing is capable of recognizing the variables and making adjustments to obtain the inventive granules in particle form.

The inventive particles are then dried to a temperature of from about 115 to about 150° C. to remove excess water utilized during the agglomeration of the components. The particle is dried to a total moisture content of 8% or less in accordance with ASTM standard D 5033 Volume 11.04. The particles optionally have total moisture content of 5 total weight percent or less. The upper temperature limitation during the drying step prevents the degradation or burning of the organic binder. The particles are optionally dried in conventional drying units such as, for example, a fluid bed dryer, or a rotary dryer.

The resulting pelletized material is then screened to remove oversized and undersized particles. The improperly sized material is optionally recycled to the mixing stage or milled to the appropriate size and rescreened. In some inventive embodiments, the finished product is sprayed with a lightweight mineral oil to further prevent dusting of the product in bulk form.

The strength of the particles is determined through the crush strength test, ASTM E 382 Volume 3.06, and resistance to attrition (RTA) test, ASTM E 728-91 Volume 11.04. In some inventive embodiments, manufactured particles of the present invention have a crush strength between 2 and 6 pounds on an 8 mesh (2.38 mm) particle. Additionally, the particles in some inventive embodiments have an RTA value of at least 85%.

The resulting granular carrier particle based inventive particles in some inventive embodiments have a smooth surface and are spherical in shape. The sphericity lends to desired flow characteristics of the granules in bulk form. The angle of repose is a test utilized to measure the ability of particles to flow in bulk form. The test is conducted on a 14×30 mesh sample. The particles of the present invention optionally all have an angle of repose of 35 degrees or less.

Embodiments of the inventive particle function as an herbicide for broadleaf weeds and mosses.

Particles are administered by a method that delivers the particles to the vicinity of the target plant.

Various aspects of the present invention are illustrated by the following nonlimiting examples. The examples are for illustrative purposes and are not a limitation on any practice of the present invention. It will be understood that variations and modifications can be made without departing from the spirit and scope of the invention.

### EXAMPLES

### Example 1

10 kilograms of powdered lysine particles have an mean particle diameter of 0.1 mm are placed in a Forberg mixer. 4.7 kilograms of iron(2+) sulfate heptahydrate and mixed with 0.6 liters of water and The mixture is added to the Forberg mixer and stirred together until the coated particles are free flowing.

### Example 2

Using a pan agglomeration disc, iron(EDTA) powder and powdered lysine are adhered to carrier particle of wood flour and limestone having an average diameter of 1 mm with 90% by weight of the particles being in the size range of between 0.3 mm and 3 mm using in an amount of calcium lignosulfonate to achieve carrier particles with iron present at 1 wt. % and lysine present at 0.65% by weight to achieve an iron: lysine stoichiometry of 1:2. The particles are dried at a temperature of 45° C. to a moisture content of less than 0.5%. The particles are then separated into various size categories using conventional gyroscopic screeners. The particles retain an average diameter of 1 mm with 90% by weight of the particles being in the size range of between 0.3 mm and 3 mm and.

### Example 3

The material of Example 1 is reproduced with iron sulfate in place of iron(EDTA).

### Example 4

The material of Example 1 is reproduced with iron oxide in place of iron(EDTA).

### Example 5

The material of Example 1 is reproduced with a diluted and neutralized solution of monamino acids produced by HCl hydrolysis of chicken features in place of powdered lysine.

### Example 6

A solution of iron sulfate heptahydrate and lysine is prepared that is 0.25% Fe and has a 1:2 stoichiometric ration of iron: lysine.

### Comparative Example

A liquid solution of iron(EDTA) (0.25 wt. % Fe) is prepared lacking amino acids.

### Example 6

The particles of Example 1-4 and the solutions of Example 5 and the comparative Example of are spread onto moss in an amount of 1 gram per square meter or 100 ml per square meter. After 21 days, Examples 1-4 had control rates of the Example 1>Example 3=Example 4>Example 5>Example 2>Comparative Example. With Examples 1-5 affording excellent control, while Example 2 provided limited control and the Comparative Example only marginally better than a negative control of carrier particles without either iron or amino acids.

### Example 7

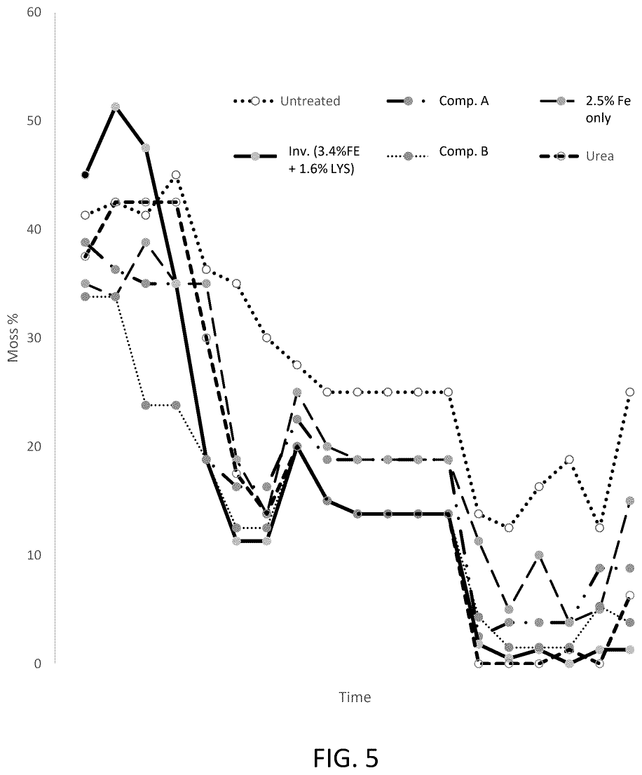

A study was conduct in Illinois on a grid plot of golf course turn grass to study the moss percentage from May 19 to Oct. 14, 2025 as shown in FIG. 5 with these dates represent the left most and right most points of the X-axis, respectively. This plot shows a consistent decline in moss coverage across all treatments throughout the season. Initially, moss coverage is relatively high, with untreated plots around 41% and treated plots ranging from about 34% to 45%. As the season progresses into mid-summer, moss percentages steadily decrease, with treated plots generally exhibiting lower moss levels than untreated ones. By late season, moss coverage is significantly reduced, especially in treatments like Comparative A (half rate of 21.3% carfentrazone-ethyl), Invention 1 (3.4%Fe & 1.6% Lysine) that was formed by the methods of Examples 1 and 2, Comparative B (half rate of 26.52% Iron bonded to hydroxyethylenediaminetriacetic acid) and Urea (0.15 poundsN/M), which often show moss percentages below 10%, sometimes nearing zero. Untreated plots maintain higher moss percentages overall but also show a downward trend, dropping from around 25% in early September to about 12.5% in early October before rising slightly again by mid-October. Overall, all treatments effectively suppress moss growth, with Invention 1 and Urea demonstrating the most pronounced reductions by the end of the season. Furthermore, Invention 1 showed no phytotoxicity as to the surrounding turf and in contrast to several of the comparatives.

Any patents or publications mentioned in this specification are indicative of the level of those skilled in the art to which the invention pertains. These patents and publications are herein incorporated by reference to the same extent as if each individual publication was specifically and individually indicated to be incorporated by reference.

One skilled in the art will readily appreciate that the present invention is well adapted to carry out the objects and obtain the ends and advantages mentioned, as well as those inherent therein. The present methods, procedures, treatments, molecules, and specific compounds described herein are presently representative of preferred embodiments, are exemplary, and are not intended as limitations on the scope of the invention. Changes therein and other uses will occur to those skilled in the art which are encompassed within the spirit of the invention as defined by the scope of the claims.

1. An herbicide composition comprising:
an iron compound; and
at least one type of monoamino acid or dimer of amino acids.

2. The composition of claim 1 wherein the at least one type of monoamino acid comprises a charged amino acid, cysteine, or a combination thereof.

3. The composition of claim 1 wherein the at least one monoamino acid is hydrolyzed protein.

4. The composition of claim 3 wherein the hydrolyzed protein is derived from features, hair, offal, dried distillers grain, or animal waste.

5. The composition of claim 1 wherein the iron compound is an Fe(2+) or Fe(3+) salt of any one of chloride, sulfate, nitrate, acetate, fumarate, or formate.

6. The composition of claim 1 further comprising a carrier particle on which, in which, or a combination thereof. the at least one type of monoamino acid or dimer of amino acids is present.

7. The composition of claim 1 further comprising a carrier particle on which, in which, or a combination thereof, the iron compound is present.

8. The composition of claim 6 further comprising a binder retaining granules together to form the carrier particle or adhering granular forms of the at least one type of monoamino acid or dimer of amino acids and/or the iron compound to the carrier particle.

9. The composition of claim 8 wherein the binder component is lignin, bentonite clay, carbohydrate, protein, lipid, synthetic polymer, glycolipid, glycoprotein, lipoprotein, or combinations thereof.

10. The material of claim 9 wherein the binder component is calcium lignosulfonate.

11. The composition of any one of claims 1 wherein the at least one type of monoamino acid or dimer of amino acids form a particle with a surface coating with the iron compound or vice versa.

12. A process of promoting killing a target broadleaf plant or moss comprising:
spreading the composition of claim 1 on soil in which the target plant is growing; and
allowing the material to disperse into the soil.

13. The process of claim 12 wherein the target plant is moss.

14. The process of claim 12 wherein the spreading is by liquid spray.

15. The process of claim 12 wherein the spreading is by spreading is by broadcast of particles.
